(19) United States
(12) Patent Application Publication
(10) Pub. No.: US 2006/0093203 A1
(43) Pub. Date: May 4, 2006

(54) Attribute threshold evaluation scheme

(75) Inventor: John M. Good, North Andover, MA (US)

Correspondence Address: ROCKWELL AUTOMATION, INC./(AT), ATTENTION: SUSAN M. DONAHUE, 1201 SOUTH SECOND STREET, MILWAUKEE, WI, 53204, US

(73) Assignee: Rockwell Automation Technologies, Inc., Mayfield Heights, OH (US)

(21) Appl. No.: 11/211,332

(22) Filed: Aug. 25, 2005

Related U.S. Application Data
(60) Provisional application No. 60/624,909, filed on Nov. 4, 2004.

(51) Int. Cl. G06K 9/00

(52) U.S. Cl. 382/141

(57) ABSTRACT

A system and methodology to evaluate an image of an object based upon multiple attribute threshold values is provided. In accordance with the invention, if an attribute reading from a sensor is between pre-defined threshold values, the sensor reading can be deemed acceptable. High and low thresholds can be provided to allow a user to set an acceptable range. These high and low thresholds can be applied to inspection tools (e.g., brightness sensors). For clarification, the high and low thresholds can be applied to any measurable attribute.

### CROSS-REFERENCE TO RELATED APPLICATIONS

This application claims the benefit of U.S. Provisional Patent application Ser. No. 60/624,909 entitled “ATTRIBUTE THRESHOLD EVALUATION SCHEME” and filed Nov. 4, 2004.

### TECHNICAL FIELD

The subject invention relates generally to quality control of an industrial process, and more particularly to systems and methods that facilitate identification of failed or rejected items in manufacturing processes via image sensors and vision systems that employ multiple thresholds.

### BACKGROUND OF THE INVENTION

Industrial controllers are special-purpose computers utilized for controlling industrial processes, manufacturing equipment, and other factory automation, such as data collection or networked systems. In accordance with a control program, the industrial controller, having an associated processor (or processors), measures one or more process variables and/or inputs reflecting the status of a controlled system and changes outputs effecting control of such system.

Industrial control systems have enabled modem factories to become partially or completely automated in many circumstances. These systems generally include a plurality of input/output (I/O) modules that interface at a device level to switches, contactors, relays and solenoids along with analog control to provide more complex functions such as Proportional, Integral and Derivative (PID) control. Communications have also been integrated within the systems, whereby many industrial controllers can communicate via network technologies such as Ethernet, Control Net, Device Net or other network protocols. Generally, industrial controllers utilize the aforementioned technologies along with other technology to control, cooperate and communicate across multiple and diverse applications.

In addition, conventional control systems employ a large array of varied technologies and/or devices to achieve automation of an industrial environment, such as a factory floor or a fabrication shop. Systems employed in an automated environment can utilize a plurality of sensors and feedback loops to direct a product through, for example, an automated assembly line. Such sensors can include temperature sensors (e.g., for determining a temperature of a steel bar that is entering a roller device to press the bar into a sheet), pressure sensors (e.g., for determining when a purge valve should be opened, for monitoring pressure in a hydraulic line), proximity sensors (e.g., for determining when an article of manufacture is present at a specific device and/or point of manufacture), etc.

Proximity sensors are available in a wide variety of configurations to meet a specific sensing need. For example, proximity sensors can be end-mounted or side-mounted in a housing, etc., to facilitate mounting in confined spaces while permitting the sensor to be directed toward a sensing region as deemed necessary by a designer. Additionally, proximity sensors are available with varied sensing ranges, and can be shielded or unshielded.

However, there is a trend in industrial technology to replace traditional mechanical gauging or sensor technology with cost-saving, easy-to-use vision sensors. A single vision sensor can supersede measurement sensors, proximity, and photoelectric sensor arrays, or mechanical gauges in performing inspection and/or measurement. For example, a vision sensor can be, but is not limited to, a low end vision system, a vision camera, camera sensor, and/or smart camera. General benefits of vision sensors over traditional mechanical gauging and sensor technology include: lower costs for installation, calibration, and maintenance; online accessibility to add new inspections and/or measurement capabilities; quality and efficiency; and improved functionality.

Typically, vision sensors are available in two hardware configurations: an all-in-one “smart camera” or a remote camera. The smart camera is a standalone unit where a light source, lens, camera, and processor/controller are in a single package. On the other hand, a remote camera is a separate unit containing the remote camera, lens, and light source while the processor/controller is separately contained.

Furthermore, each hardware configuration provides associated software in order to mitigate setup and configuration. Traditional software utilizes a pushbutton interface in order to “teach” the sensor bad and/or good parts allowing self-contained configuration. For example, a pushbutton interface can be utilized to teach the vision sensor pattern matching, presence/absence, and/or feature comparison, wherein the pushbutton designates a “perfect model” to which a “pass” or “fail” judgment is made. Traditionally, “pass” or “fail” determinations are simply binary based upon a single threshold without extrinsic or correlated data. In other words, these traditional systems employ a single measurement attribute (e.g., contrast) for which to make a pass/fail determination.

As discussed above, vision systems, particularly low-end vision cameras, sensor cameras, and smart cameras can employ a variety of optical sensors. Many of these optical sensors are equipped with advanced inspection functionality that facilitates quality control with regard to industrial manufacturing lines. Often, quality control with regard to industrial systems (e.g., packaging, manufacturing) is based on vision techniques that can employ the acquisition of a reference image. Next, quality control can be achieved by configuring a sensor or vision system to facilitate comparing an image of a reference object with images of target objects. In accordance thereto, parameters such as brightness, contrast, sharpness, clarity, etc. can be used to effect a comparison.

By way of example, some vision systems are based upon a camera and built-in image processing intelligence. These systems can compare the contrast of an image to that of a reference (e.g., calibration) image. It will be appreciated that hundreds of image zones can be compared at a rate exceeding thousands of images per minute. In doing so, these detectors can employ decision-making logic based upon a defined tolerance.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention disclosed and claimed herein, in one aspect thereof, comprises a system and/or methodology to evaluate an image of an object based upon multiple attribute threshold values. For example, if brightness from a sensor is between pre-defined threshold values, the sensor reading can be deemed acceptable. In the subject invention, high and low thresholds can be provided to allow a user to set an acceptable range. These high and low thresholds can be applied to inspection tools (e.g., brightness sensors). For clarification, the high and low thresholds can be applied to any measurable attribute.

In another aspect of the subject invention, these threshold ranges could be set as part of a software configuration. Additionally, the threshold range(s) can be rendered (e.g., displayed) as part of the sensor operation. In alternate aspects, the thresholds can be displayed on a user interface of the sensor or on a user display connected to a network. It should be understood that these high and low thresholds can be combined with two more additional parameters. As well, the thresholds can be dynamically variable as desired. For example, an artificial intelligence (AI) engine as well as intelligent programming can be employed to automatically and/or dynamically vary the thresholds to accommodate for changing conditions (e.g., ambient lighting).

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a general component block diagram of a system that employs sensor that utilizes two attribute thresholds in accordance with an aspect of the subject invention.

FIG. 2 illustrates a general block diagram of a system having an exemplary analyzer and measuring component in accordance with an aspect of the subject invention.

FIG. 3 illustrates a general block diagram of a system that employs multiple attribute thresholds and/or target attributes in accordance with an aspect of the subject invention.

FIG. 4 illustrates a two dimensional analysis technique in accordance with a disclosed aspect.

FIG. 5 illustrates a three dimensional analysis technique in accordance with a disclosed aspect.

FIG. 6 illustrates a general block diagram of a system that renders to a display in accordance with an aspect of the subject invention.

FIG. 7 illustrates an analyzer component including rule-based mechanisms in accordance with an aspect of the invention.

FIG. 8 illustrates an analyzer component including artificial intelligence-based mechanisms in accordance with an aspect of the invention.

FIG. 9 illustrates a measuring component including rule-based mechanisms in accordance with an aspect of the invention.

FIG. 10 illustrates a measuring component including artificial intelligence-based mechanisms in accordance with an aspect of the invention.

FIG. 11 illustrates an exemplary flow chart of procedures to set thresholds and evaluate a target image in accordance with a disclosed aspect.

FIG. 12 illustrates a component diagram of an exemplary computing environment in accordance with an aspect of the subject invention.

FIG. 13 illustrates a block diagram of a computer operable to execute the disclosed architecture.

FIG. 14 illustrates a schematic block diagram of an exemplary computing environment in accordance with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention can be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

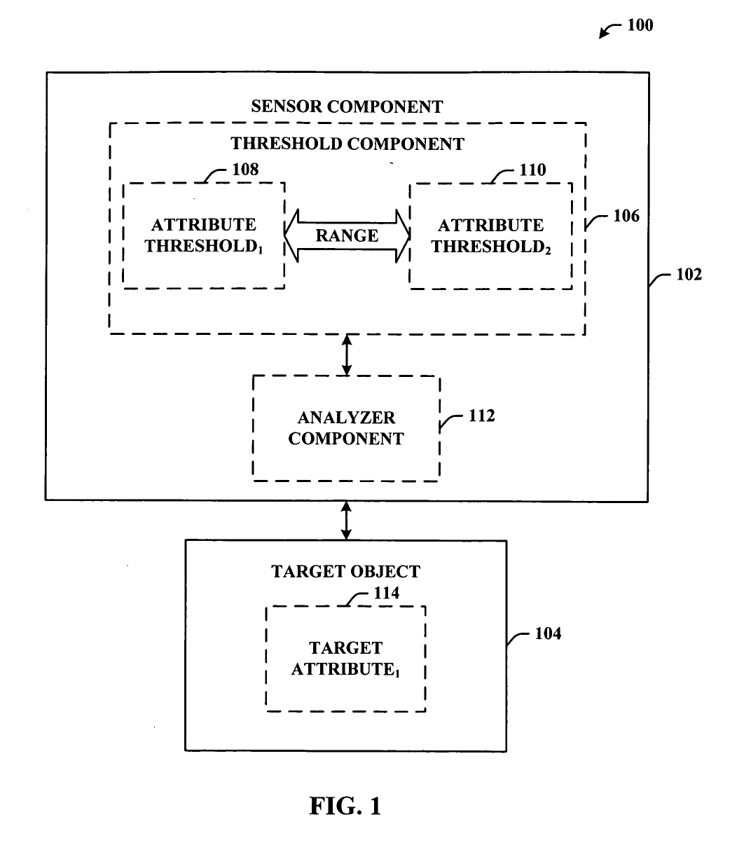

Referring initially to FIG. 1, a vision system 100 is shown. Generally, system 100 can include a sensor component 102 that can detect and process images of a target object 104 based upon a reference object or image (not shown). More particularly, the sensor component 102 can include a threshold component 106 having a first attribute threshold 108 and a second attribute threshold 110. As illustrated, a range (e.g., band) can be defined therebetween. Additionally, the sensor component 102 can include an analyzer component 112 that facilitates comparing a target attribute 114 to the attribute thresholds (108, 110).

By way of example, suppose the sensor 102 is configured to detect and analyze attribute (e.g., contrast) values of a specific pixel region of a target object 104 with respect to a reference object (not shown). Such analysis can be accomplished by comparing a target attribute 114 to a range defined by at least two attribute thresholds (108, 110). It will be appreciated that any method of programming the attribute thresholds 108, 110 known in the art can be employed. In one exemplary aspect, an image can be taken of a reference object (not shown) whereby the system 100 can interpolate a threshold range from a pixel's median contrast value. In another exemplary aspect, multiple images can be taken of a reference object whereby pixel contrast values can be input into a desired algorithm to calculate acceptable attribute thresholds (108, 110) or limits.

Continuing with the example, the sensor component 102 can measure the contrast value (e.g., target attribute 114) of the target object 104 whereby the analyzer component 112 can compare the received value of the target attribute 114 to the attribute thresholds (108, 110). Accordingly, the system 100 can determine if the target object 104, or image thereof, is a “pass” or “fail” object or image as a function of the comparison.

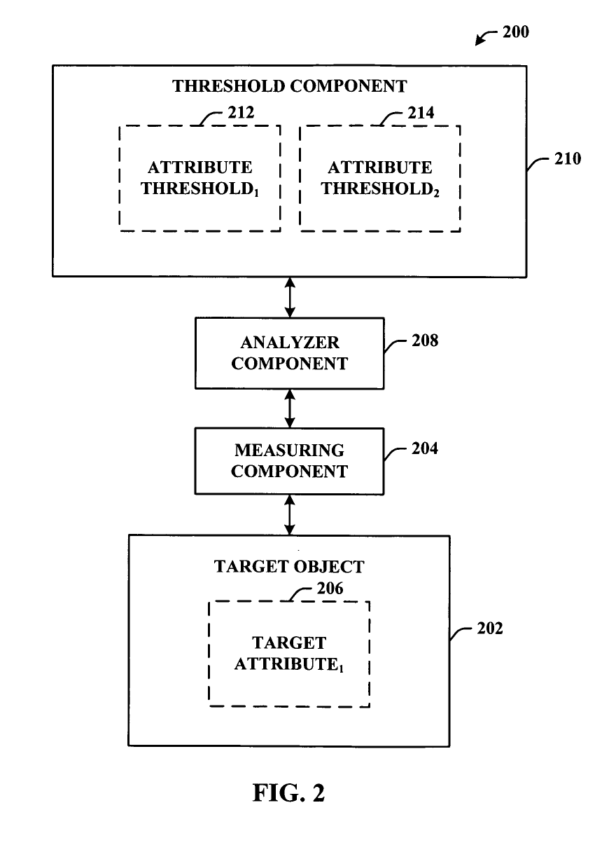

Turning now to FIG. 2, as described supra, vision systems (e.g., system 200) can employ various measuring methods to detect a target object 202. As well, images of the detected target object 202 can be evaluated and/or processed as desired. In one example, an area sensor (e.g., measuring component 204) can employ a pattern matching technique with or without position control. Area tests such as contrast and gray-level can also be utilized by the measuring component 204. It will be appreciated that other methods including, but not limited to, completeness check, positional arrangement verification, imprint and label check, emptiness check, edge detection, etc. can be employed by the measuring component 204.

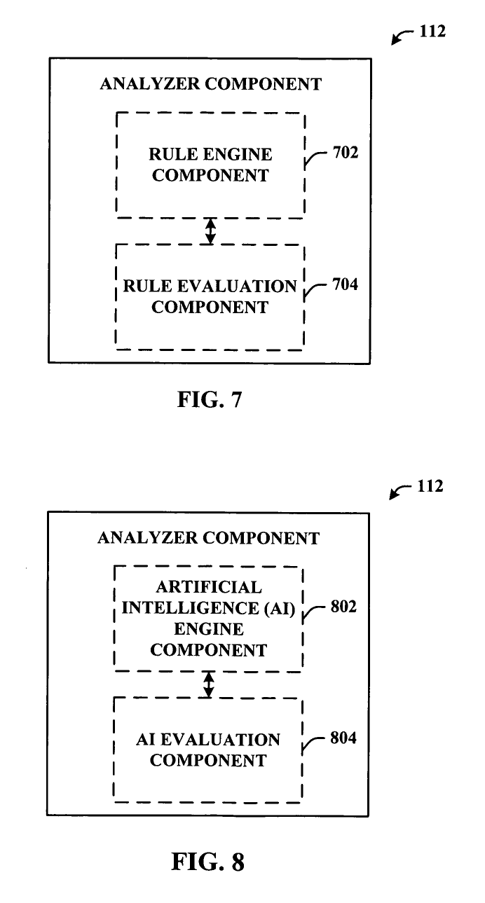

In one example, the pixel resolution of an image can be utilized to compare a target image 202 to a reference image (not shown). In other words, once the measuring component generates a target attribute 206 with respect to the target object 202, an analyzer component 208 can be employed to compare this target attribute 206 to a threshold component 210. As discussed supra, the threshold component 210 can include two (or more) individual attribute thresholds 212, 214 which define a range therebetween. It will be appreciated that these attribute thresholds 212, 214 can be defined in relation to a reference object. As well, the attribute thresholds 212, 214 can be programmed in accordance with any user preference. In yet other aspects, the attribute thresholds 112, 114 can be configured and dynamically varied via rule based and/or artificial intelligence (AI) techniques. These alternative techniques will be discussed in greater detail with reference to FIGS. 7-10 infra.

In an alternate aspect, a gray scale method can be employed by the analyzer component 208 to compare the target attribute 206 and reference image (e.g., attribute thresholds 212, 214). It will be understood that the gray scale method can compare the luminance of the respective pixel value. Further, those skilled in the art will understand that the gray scale levels can range from 1 to 255 representing black to white respectively.

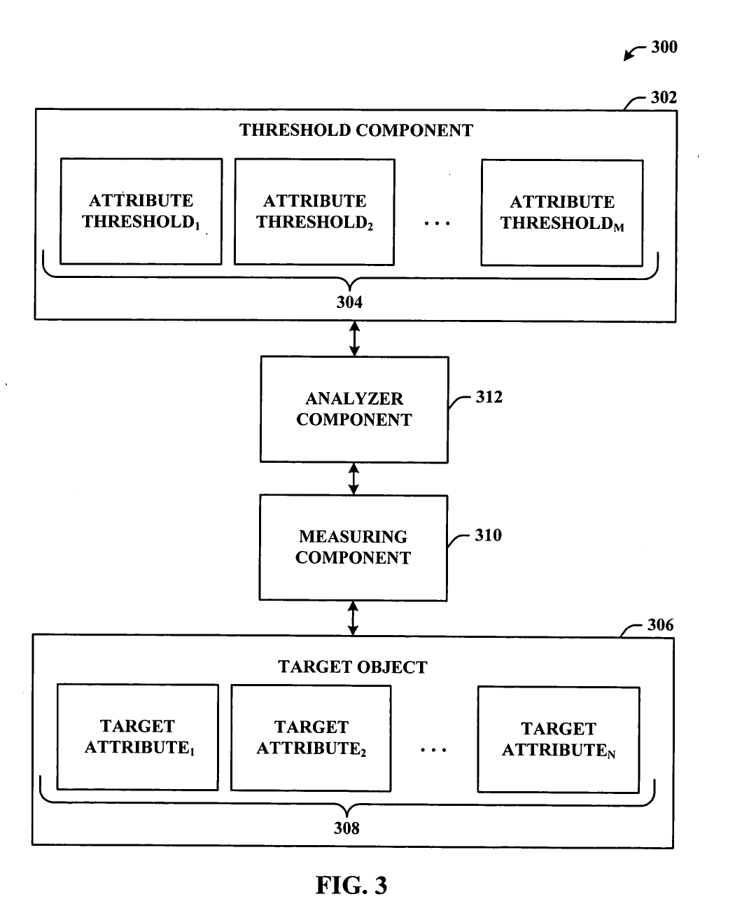

Although the aspects described herein are directed to specific techniques, it is to be understood that a core novel aspect of the subject invention is the multi-threshold and multi-attribute comparison techniques. This novel aspect can be better understood with reference to FIG. 3.

With reference now to FIG. 3, an alternative exemplary system 300 is shown. As illustrated, the threshold component 302 can include 1 to M attribute thresholds, where M is a positive integer. Attribute thresholds 1 to M can be referred to individually or collectively as attribute threshold 304. Likewise, target object 306 can include 1 to N target attributes, where N is a positive integer. Target attributes 1 to N can be referred to individually or collectively as target attributes 308.

In operation, measuring component 310 can detect one or more target attributes 308. The analyzer component 312 can, in turn, process the target attributes 308 as a function of one or more attribute thresholds 304 in order to determine an outcome (e.g., “pass” or “fail”). For example, the target attributes 308 can be compared to the attribute thresholds 304 in order to determine a “passed” or “failed” object on an industrial assembly line.

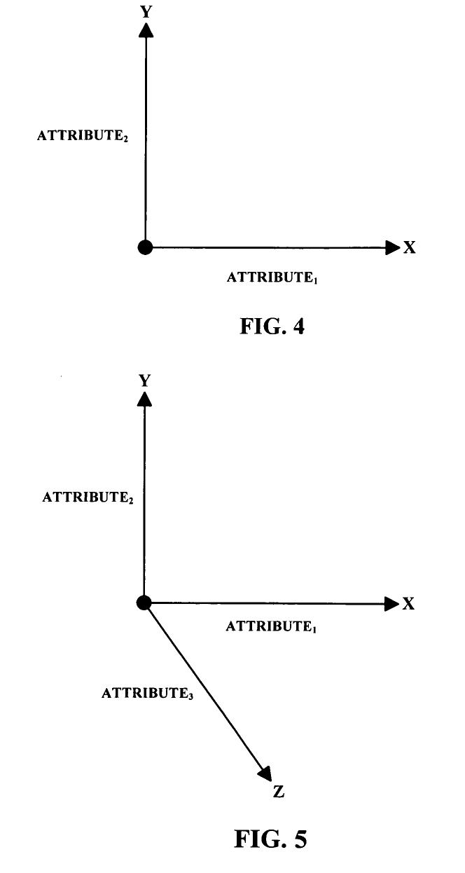

FIGS. 4 and 5 further illustrate the multiple threshold concepts. FIG. 4 illustrates an exemplary bi-attribute system. As illustrated, the attribute thresholds (e.g., 304 of FIG. 3) can be graphically rendered on an X-Y axis. For example, the X-axis can represent one attribute whereas a disparate attribute can be applied to the Y-axis. In order to demonstrate this concept, suppose a contrast attribute and corresponding thresholds is employed on the X-axis and a brightness attribute and corresponding thresholds on the Y-axis. In operation, the system can analyze target attributes corresponding to contrast and brightness by graphically displaying these attributes on the X-Y axis representation. If the target attribute values fall within acceptable threshold limits, the system can deem the image as “passed.” Likewise, if the target attributes do not fall within the acceptable limits, the target image can be deemed as a “failed” image.

FIG. 5 illustrates yet another alternative analysis system. As shown, a tri-attribute analysis method can be employed. The analysis system shown in FIG. 5 is similar to that of FIG. 4 however, an additional axis (e.g., Z) is employed. Accordingly, the system can measure a third attribute to be compared to the three attributes and corresponding thresholds as shown. In operation, a graphical representation can be shown that depicts the location based upon the three target attributes with respect to the attribute thresholds. Although the illustrated aspects are directed to bi and tri-attribute systems, it is to be appreciated that any number of attributes can be employed in connection with alternative systems without departing from the spirit and scope of the subject invention and corresponding claims. As well, it is to be understood that the vertex of each axis representation of FIGS. 4 and 5 can represent any value. In other words, the vertex (e.g., lower threshold value) with respect to the X-axis can represent a value of zero whereas the vertex with respect to the Y-axis can represent another value (e.g., 10).

Following is a discussion of the various evaluation methods noted supra. The discussion that follows is provided to add context to the subject invention and is not intended to limit the invention in any way. It will be appreciated that any evaluation technique known in the art can be employed in connection with the subject invention without departing from spirit and/or scope of the claims attached hereto. More particularly, the discussion of the exemplary aspects that follow is directed to a gray level area test, a contrast area test and a pattern matching/position control test.

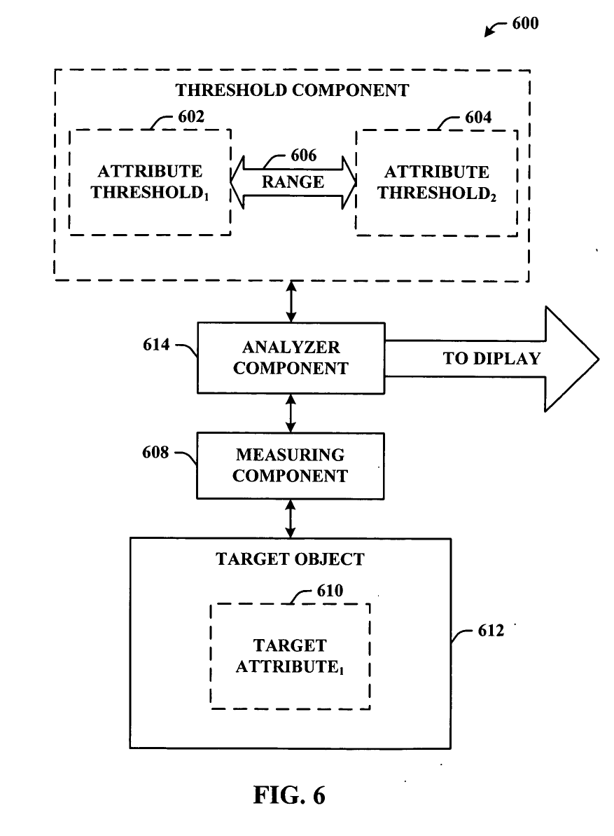

Referring now to FIG. 6 and with respect to the gray level area test, in one aspect, the system 600 can be set to determine a specific number of black pixels in an image. For example, the first attribute threshold 602 can be set at an arbitrary number (e.g., 64). Likewise, the second attribute threshold 604 can be set at an arbitrary number (e.g., 128). As described supra, a measuring component 608 can be employed to set the threshold attributes 602, 604 based upon a reference image (not shown).

As illustrated, the range 606 (e.g., range) can represent a range of the number of pixels from 64 to 128. Accordingly, this range 606 defines the number of black pixels permitted in a “passed” target image 610. It will be understood that the position of these black pixels can be irrelevant with regard to this test. As well, an analyzer component 614 can be employed to process an image of the target object 612 and render the results to a display as shown. Additionally, the result(s) of the analysis can be rendered to an application in lieu of or in addition to a visual display. Moreover, audible and visual alarms can be employed to notify a user of the results of the analysis.

As well, those skilled in the art will appreciate that the threshold values (602, 604) can be set automatically in alternative aspects. For example, the threshold values (602, 604) can be set in accordance with individual properties of a reference image. In another example; qualities of a “passed” and “failed” image can be parameterized whereby a predefined rule and/or AI can be applied to determine the thresholds (602, 604) therefrom. These alternative automatic methods of determining the thresholds (602, 604) will be discussed with respect to FIGS. 7-10 infra.

In another exemplary aspect, an area test based upon contrast can be employed. In this aspect, pixels are rated with respect to quality and/or intensity. In other words, dark and bright pixels can project varying quality and/or intensity values. In operation the target object 612 can be placed in any position on an assembly line. As well, in a gray scale example, the target object 612 can be of any shape and/or color. As previously described, it will be appreciated that the system 600 can be calibrated (e.g., setting of thresholds 602, 604) based upon a reference image. Next, the system can compare the reference image to an image of the target object 612.

In yet another exemplary aspect, pattern matching or position control can be employed to determine a “passed” or “failed” image. In accordance with this method, the measuring component 608 can store an image of the reference object (not shown). Once stored, images of target objects (e.g., 612) can be compared to the reference image by the analyzer component 614 utilizing pattern matching. For example, tolerance values (e.g., attribute thresholds 602, 604) that represent rotational values can be employed to accept and/or reject an image.

By way of further example, a tolerance range 606 can be set from +5 to +15 degrees from center. In other words, the first threshold value 602 can be set at +5 and likewise, the second threshold value 604 can be set at +15 degrees. Thus, a +10 degree range 606 is defined. In these examples, a specific portion of the target object 612 (e.g., product label) can be pinpointed. For instance, a part number identified on the reference object label can be cropped whereby the measuring component 608 can identify the location of this portion of the label. Accordingly, thresholds 602, 604 (e.g., pattern similarity) can be set with respect to the cropped portion. In one example, these thresholds 602, 604 can include the position of this portion of the label. Accordingly, the analyzer component 614 can identify if the target object 612 complies with the tolerances 602, 604 set with respect to a reference object (e.g., image).

As noted supra, is to be appreciated these exemplary aspects are included to provide context to the invention and its corresponding functionality and/or processing features. The exemplary aspects are not intended to limit the scope and/or functionality of the invention in any way.

With reference now to FIG. 7, an alternate aspect of an analyzer component (e.g., 112 of FIG. 1) is shown. More particularly, analyzer component 112 can include a rule engine component 702 and a rule evaluation component 704. In accordance with this alternate aspect, an implementation scheme (e.g., rule) can be applied to define and/or implement a desired evaluation method. It will be appreciated that the rule-based implementation can automatically and/or dynamically define and implement an evaluation scheme of a target object. In accordance thereto, the rule-based implementation can evaluate a target object attribute (or attributes) by employing a predefined and/or programmed rule(s) based upon any desired criteria (e.g., attribute type, attribute weight).

By way of example, a user can establish a rule that can implement an evaluation based upon a preferred hierarchy (e.g., weight) of an attribute. In this exemplary aspect, the rule can be constructed to evaluate a target image based upon one attribute whereby if the target does not comply with set thresholds, the system can evaluate another attribute(s) to validate the status (e.g., “pass” or “fail”). For example, if a target image is deemed “failed” based upon one attribute (e.g., alignment) thresholds, the system can be programmed to further examine the target and make a decision(s) based upon other attributes (e.g., contrast). It will be appreciated that any of the attributes utilized in accordance with the subject invention can be programmed into a rule-based implementation scheme.

A schematic diagram of another alternative aspect of the analyzer component 112 is illustrated in FIG. 8. In addition to or in place of the rule-based components described with reference to FIG. 7, the analyzer component 112 can include an AI engine component 802 and an AI evaluation component 804.

In accordance with this aspect, the optional AI engine and evaluation components 802, 804 can facilitate evaluation and decision-making in connection with various functional aspects of the analyzer component 112. The AI components 802, 804 can optionally include an inference component (not shown) that can further enhance automated aspects of the AI components 802, 804 utilizing, in part, inference based schemes to facilitate inferring intended actions. The AI-based aspects of the invention can be effected via any suitable machine-learning based technique and/or statistical-based techniques and/or probabilistic-based techniques.

In the alternate aspect, as further illustrated by FIG. 8, the subject analyzer component 112 (e.g., in connection with evaluating attributes) can optionally employ various AI based schemes for automatically carrying out various aspects thereof. Specifically, an AI engine and evaluation component 802, 804 can optionally be provided to implement aspects of the subject invention based upon AI processes (e.g., confidence, inference). For example, a process for determining a “passed” or “failed” status based upon specific attribute weights can be facilitated via an automatic classifier system and process. Further, the optional AI engine and evaluation components 802, 804 can be employed to facilitate an automated process of evaluating in accordance with changing ambient conditions. In other words, the AI components 802, 804 can be employed to dynamically vary acceptable threshold limits in accordance with external factors (e.g., ambient lighting).

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the invention can employ classifiers that are explicitly trained (e.g., via a generic training data) as well as implicitly trained (e.g., via observing user behavior, receiving extrinsic information). For example, SVM's can be configured via a learning or training phase within a classifier constructor and feature selection module. In other words, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

Other implementations of AI can include, but are not limited to, alternative aspects whereby, based upon a learned or predicted user intention, the system can deem a target image as “passed” or “failed.” Likewise, an optional AI component could prompt a user to further evaluate a target object as well as identify repeated attribute variances.

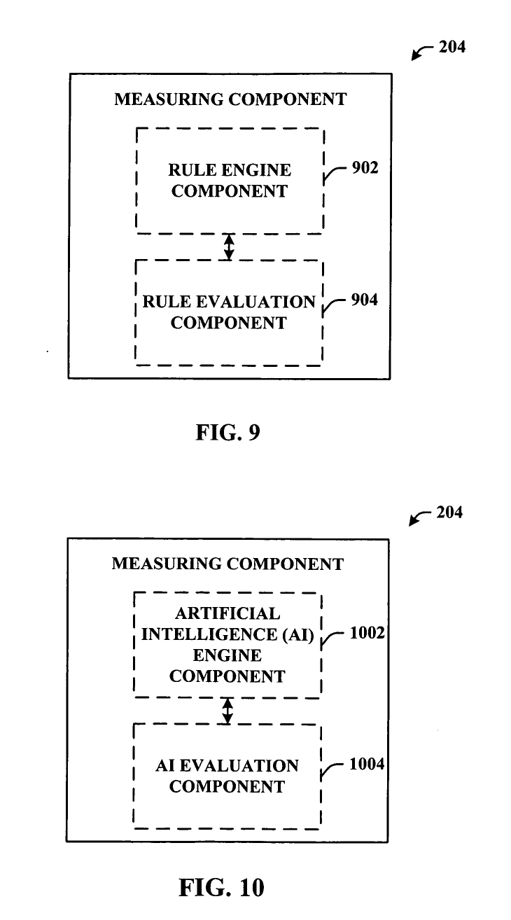

FIGS. 9 and 10 illustrate similar rule-based and AI-based components as discussed supra. The alternative measuring component 204 employs a rule engine component 902 and a rule evaluation component 904. Similarly, FIG. 10 illustrates an alternate aspect of a measuring component 204 that employs AI-decision based mechanisms (1002, 1004). More particularly, FIG. 10 illustrates an AI engine and evaluation components included within a measuring component 204. It is to be appreciated that the rule-based and AI-based decision logic and reasoning/learning mechanisms shown in connection with automating the measuring component of FIGS. 9 and 10 have the same and/or similar functionality as those described supra with reference to FIGS. 7 and 8. By way of example, the AI components 1002, 1004 illustrated in FIG. 10 can facilitate automatically instructing the measuring component 204 to adjust measuring parameters and/or schemes in accordance with changes in ambient conditions.

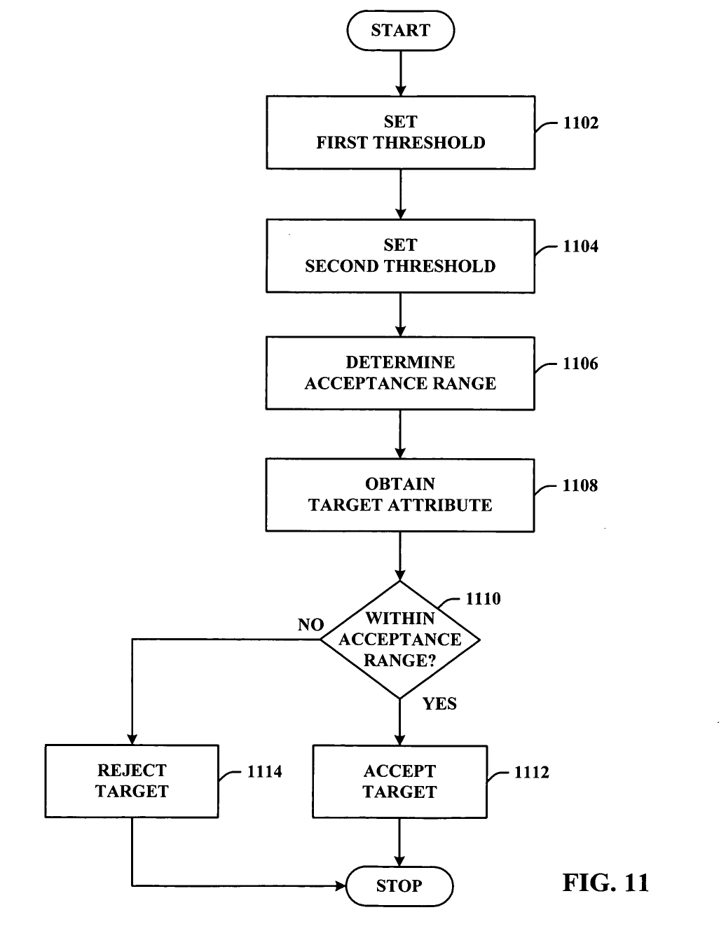

With reference now to FIG. 11, there is illustrated an exemplary flowchart of evaluating a target in accordance to an aspect of the with the subject invention. While, for purposes of simplicity of explanation, the methodology shown herein, e.g., in the form of a flow chart, is shown and described as a series of acts, it is to be understood and appreciated that the subject invention is not limited by the order of acts, as some acts may, in accordance with the subject invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Referring now to FIG. 11, a first and second threshold can be established at 1102 and 1104. As described in greater detail supra, the thresholds can be established in any desired manner. For example, the thresholds can be based upon a reference object. In other aspects, the thresholds can be user defined. Once established, a band (e.g., range) can be determined at 1106.

Once the thresholds are established and set, target attributes can be obtained at 1108. At 1110, the system can determine if the target attribute is within the range (e.g., between the identified thresholds. If the target attribute falls within the range, the system can deem the target as a “passed” image at 1112. On the other hand, if the target attribute is not within the range, the system can deem the target as a “failed” object at 1114 as illustrated.

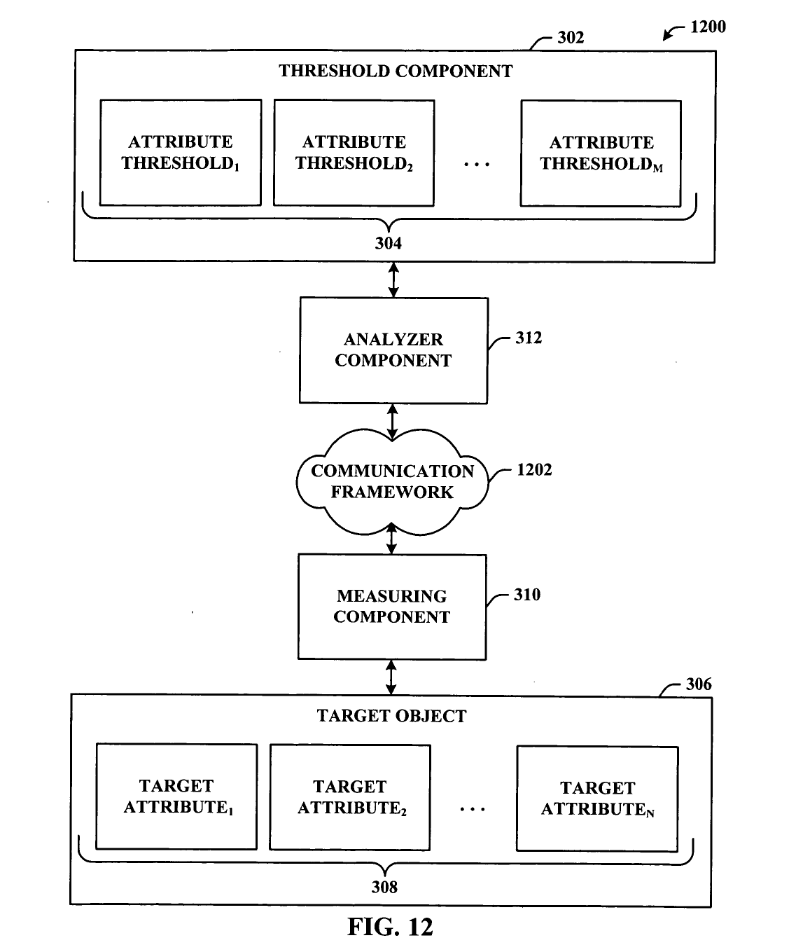

Referring to FIG. 12, a schematic block diagram of an exemplary computing environment is shown in accordance with an aspect of the subject invention. Specifically, the system 1200 illustrated includes threshold component 302 having attribute thresholds 304 defined therein. Further, the system 1200 includes a target object 306 having target attributes 308 associated therewith. An analyzer component 312 and a measuring component 310 are also included. These components can have the same functionality as discussed in detail supra with reference to FIG. 3. Additionally, the system 1200 illustrated employs a communication framework 1202 whereby the analyzer component 312 and the threshold component 302 can be remote from the measuring component 310 (e.g., sensor) and target object 306. Communications framework 1202 can employ any communications technique (wired and/or wireless) known in the art. For example, communications framework 1202 can include, but is not limited to, Bluetooth™, Infrared (IR), Wi-Fi, Ethernet, or the like.

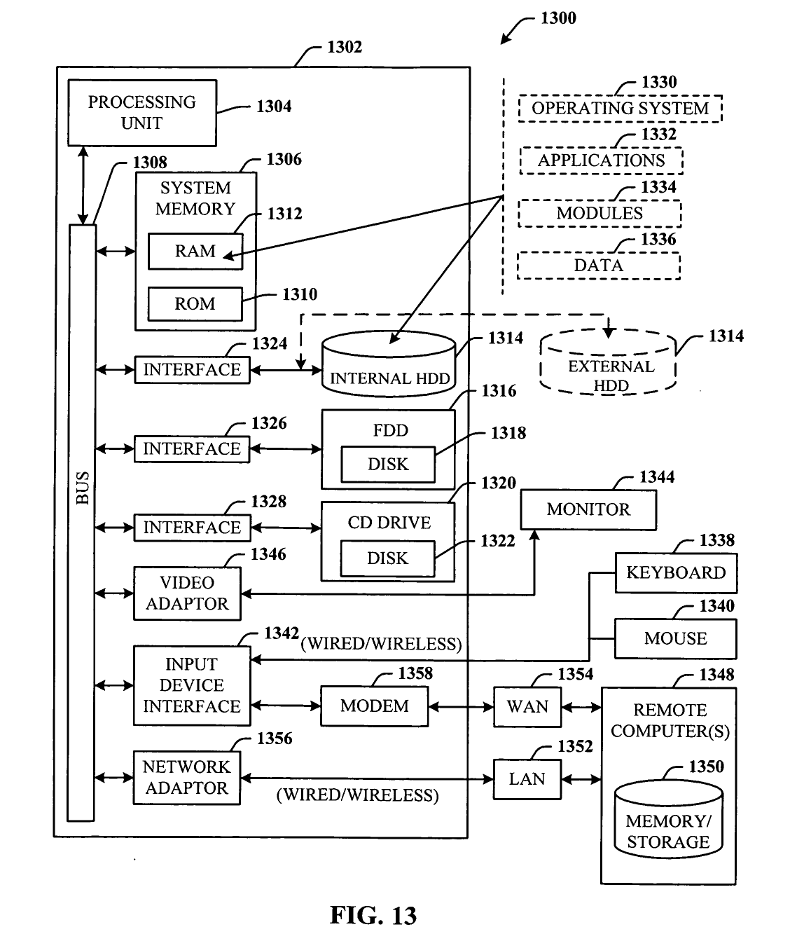

Referring now to FIG. 13, there is illustrated a block diagram of a computer operable to execute the disclosed architecture. In order to provide additional context for various aspects of the subject invention, FIG. 13 and the following discussion are intended to provide a brief, general description of a suitable computing environment 1300 in which the various aspects of the subject invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, there is illustrated an exemplary environment 1300 for implementing various aspects of the invention that includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the subject invention.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the subject invention can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1302 is connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356. When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

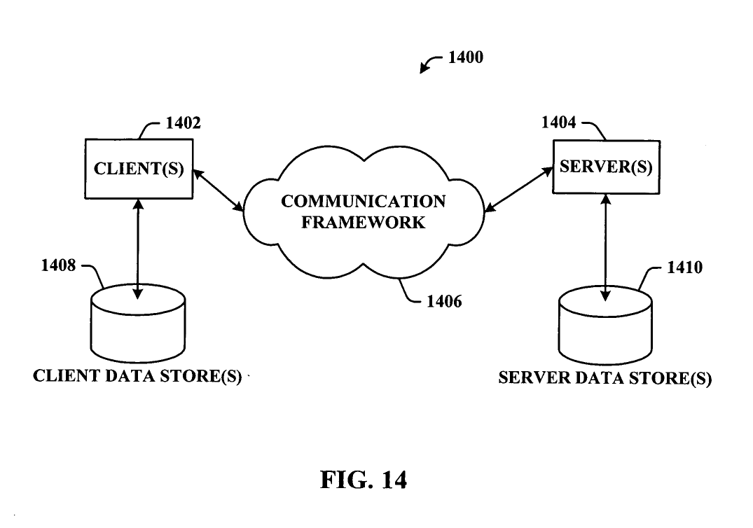

Referring now to FIG. 14, there is illustrated a schematic block diagram of an exemplary computing environment 1400 in accordance with the subject invention. The system 1400 includes one or more client(s) 1402. The client(s) 1402 can be hardware and/or software (e.g., threads, processes, computing devices). The client(s) 1402 can house cookie(s) and/or associated contextual information by employing the subject invention, for example. The system 1400 also includes one or more server(s) 1404. The server(s) 1404 can also be hardware and/or software (e.g., threads, processes, computing devices). The servers 1404 can house threads to perform transformations by employing the subject invention, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates optical evaluation of an image, the system comprising:
a first attribute threshold that defines a first acceptable limit of an attribute;
a second attribute threshold that defines an acceptance range based upon the first attribute threshold; and
an analyzer component that determines if a value of the attribute with respect to the image is within the acceptance range.

2. The system of claim 1, further comprising a component that displays the value of the attribute as a function of the acceptance range.

3. The system of claim 1, the attribute is contrast.

4. The system of claim 1, the attribute is one of contrast, brightness, clarity and sharpness.

5. The system of claim 1, further comprising at least a third attribute threshold that facilitates evaluating the image based upon a disparate attribute.

6. The system of claim 1, further comprising a component that measures the value of the attribute corresponding to a target object.

7. The system of claim 6, the component that measures the value of the attribute is located remotely from the analyzer component.

8. A user interface that employs the system of claim 1.

9. The system of claim 1, the analyzer component comprises:
a rule engine component that automatically instantiates a rule that implements a predefined criteria; and
a rule evaluation component that applies the rule with respect to the acceptance range.

10. The system of claim 1, the analyzer component comprises an artificial intelligence (AI) component that predicts a user intention as a function of historical user criteria.

11. The system of claim 10, the AI component comprises an inference component that facilitates evaluation of the image as a function of the predicted user intention.

12. The system of claim 11, the inference component employs a utility-based analyses in performing the evaluation.

13. The system of claim 11, the inference component employs a statistical-based analysis to infer an action that a user desires to be automatically performed.

14. A method for evaluating an image of a target object, the method comprising:
establishing a first limit of an attribute;
establishing an acceptance range with respect to the attribute, the acceptance range is defined by a second limit of the attribute in relation to the first limit; and
determining if a value of the attribute corresponding to the image is within the acceptance range.

15. The method of claim 14, further comprising displaying the value of the attribute as a function of the acceptance range.

16. The method of claim 14, the attribute is one of contrast, brightness, clarity and sharpness.

17. The method of claim 14, further comprising:
defining a third attribute threshold based upon a disparate attribute; and
evaluating the image based upon the third attribute threshold.

18. The method of claim 14, further comprising measuring the value of the attribute corresponding to a target object.

19. A system that facilitates assessment of a target image, the system comprising:
means for establishing a first threshold of an attribute;
means for establishing a second threshold of the attribute; and
means for comparing a value of the attribute of the target image to the first and second thresholds.

20. The system of claim 19, further comprising means for displaying the value of the attribute of the target image in relation to the first and second thresholds.
